(19) United States
(12) Patent Application Publication
(10) Pub. No.: US 2025/0242656 A1
(43) Pub. Date: Jul. 31, 2025

(54) Thermal Battery and Related Method of Use

(71) Applicant: SenergyK Innovative Creations Inc., Saskatoon (CA)

(72) Inventors: Soheil Akbari, Saskatoon (CA); Chad Roth, Saskatoon (CA)

(21) Appl. No.: 19/033,220

(22) Filed: Jan. 21, 2025

Related U.S. Application Data
(60) Provisional application No. 63/625,005, filed on Jan. 25, 2024.

(51) Int. Cl. B60H 1/00

(52) U.S. Cl. CPC B60H 1/00328; B60H 1/00278

(57) ABSTRACT

A thermal battery and related method of use comprises a thermal core configured to store and release thermal energy, a housing having an enclosed interior receiving the thermal core therein and a heat exchanger inside the housing and configured to (i) circulate a heat transfer medium around the core and (ii) extract thermal energy from the heat transfer medium for release outside the thermal battery. Ducting inside the housing fluidically interconnects the heat exchanger and a space around the core. The core comprises an enclosed container with thermally conductive outer walls, a phase change material received therein, an array of compartments defining substantially separate volumes receiving the phase change material and thermally connected to the outer walls of the container, and heating devices in the core and in thermal contact with the compartments for heating the phase change material.

### CROSS-REFERENCE TO RELATED APPLICATIONS

This application claims benefit under 35 U.S.C. 119(e) of U.S. Provisional Application No. 63/625,005, filed Jan. 25, 2025, the entirety of which is incorporated herein by reference.

### FIELD OF THE INVENTION

The present invention relates to a thermal battery and method of use thereof, and more particularly to such a battery and related method in which there is a thermal core receiving a phase change material, a surrounding enclosure in which the thermal core is received and a heat transfer assembly for circulating a fluidic heat transfer medium to extract heat from the thermal core.

### BACKGROUND

It is challenging to heat constituent parts of an electric vehicle such as its occupant cabin or batteries because an electric vehicle generates little waste heat compared to a vehicle powered by an internal combustion engine. When the electric vehicle is not moving there is virtually no waste heat being generated.

When the ambient temperature is below about 0° C., a heat pump operating with commonly used refrigerants in the automotive industry, such as R134a and R1234yf, is unsatisfactory for harvesting heat from the ambient environment because the refrigerant cannot physically exist as a low temperature vapour at high enough pressure to deliver satisfactory heating power.

Thus, generally, there is not enough or consistent waste heat coming from the batteries and drivetrain alone to adequately and reliably warm a cabin of the electric vehicle if it is cold outside. In such a scenario, electric vehicles may use electric heating, powered by the traction battery that also propels the vehicle, such that heating acts to drastically reduce driving range of the battery. Such a challenge is exacerbated in electric buses where the cabin is large and the doors are frequently opening and there is a large heat demand to keep the cabin warm.

### SUMMARY OF THE INVENTION

There is a desire for a reliable and non-intermittent heat source suited for use in an electric vehicle or in stationary applications. In the case of an electric vehicle, such a heat source is configured not to consume a substantial amount of electrical power from the vehicle's traction battery.

It is an aspect of the invention to provide such a heat source which is thermally insulated and rechargeable with electricity, rather than a fossil fuel-based burner, so that the thermal battery is configured to be concurrently recharged with the traction battery at a charging station.

According to an aspect of the invention there is provided a thermal battery comprising:
a thermal core configured to store and release thermal energy;
a housing having an enclosed interior receiving the thermal core therein;
a heat transfer assembly inside the housing, wherein the heat transfer assembly comprises a fluidic pump configured to circulate a fluidic heat transfer medium in the interior of the housing for extracting the thermal energy from the thermal core and a heat exchanger configured to extract the thermal energy from the heat transfer medium for release outside the thermal battery;
wherein the interior forms ducting around the thermal core and between the thermal core and the heat transfer assembly for conveying the heat transfer medium across outer surfaces of the thermal core to extract the thermal energy therefrom;
wherein the thermal core comprises:
a container having peripheral walls forming a core interior distinct from the interior of the housing, wherein the peripheral walls define the outer surfaces of the thermal core across which the heat transfer medium is conveyed, wherein the peripheral walls are thermally conductive;
phase change material received in the core interior and configured to store and release the thermal energy;
an array of compartments in the container dividing the core interior into a plurality of substantially separate volumes receiving the phase change material, wherein the compartments have walls defining the substantially separate volumes and which are thermally conductive, wherein the compartments are thermally interconnected to transmit thermal energy between the substantially separate volumes, wherein the array of compartments is thermally connected to the peripheral walls of the container to transmit thermal energy thereto; and
a plurality of heating devices supported in the core interior and in thermal contact with the array of compartments, wherein the heating devices are configured to apply thermal energy to the phase change material for storage therein.

This provides an arrangement to efficiently store thermal energy in a phase change material and to extract such energy therefrom.

Preferably, the heating devices are received in select ones of the compartments which are free of the phase change material.

Preferably, in such an arrangement, each one of the heating devices is thermally connected to the walls of a corresponding one of the compartments receiving the heating device by a thermally conductive body mechanically interconnecting the heating device and the walls of the compartment.

Preferably, the compartments extend linearly along respective parallel axes within the container.

When the container is rectangular prismatic in shape, preferably, the compartments span a first one of the dimensions of the container.

Preferably, the compartments span the first dimension of the container between generally horizontally-oriented and vertically spaced-apart pair of the peripheral walls.

When the container is rectangular prismatic in shape and when the compartments extend linearly along respective parallel axes within the container oriented along one of the dimensions of the container, preferably, the heating devices span that one of the dimensions and protrude beyond the peripheral walls of the container into the interior of the housing.

In the illustrated arrangement, the compartments are formed by a lattice structure supported in the container of the thermal core.

Preferably, all of the peripheral walls of the container of the thermal core are in spaced relation to walls of the housing defining the interior thereof.

Preferably, the thermal core further includes thermally conductive fins supported in upstanding relation from the outer surfaces of the container and thermally connected to the peripheral walls of the container.

Preferably, the heat transfer assembly is configured to circulate the heat transfer medium about the thermal core from a top to a bottom thereof.

Preferably, the heat transfer assembly is operable in combination with a heat pump operatively connected to the heat exchanger so as to cooperate therewith in a heat transfer loop to release the extracted thermal energy outside the thermal battery, wherein the heat pump is configured to be actuated when a temperature of the thermal core is below a prescribed threshold temperature. This may increase the usable range of temperatures of the phase change material across which thermal energy is extractable. When the thermal core is above the threshold temperature, the heat transfer loop may bypass the heat pump. The heat pump may not be necessary for all applications, it depends on what threshold temperature is considered usable for the application as well as the physical properties of the phase change material being used. In the case of an electric vehicle, a heat pump is preferred since passengers expect high temperature air from the vents.

In the illustrated arrangement, the thermal battery further includes a vacuum pump in fluidic communication with the interior of the housing and an exterior environment of the housing. When the housing is fluidically sealed, preferably, the vacuum pump is configured to (i) release the fluidic heat transfer medium to the exterior environment of the housing, so as to form a vacuum pressure in the interior of the housing, when the heat exchanger is in an inactive state in which the heat transfer medium is not circulated, and (ii) admit the fluidic heat transfer medium to the interior of the housing from the exterior environment, when the heat exchanger is activated from the inactive state to circulate the heat transfer medium.

When the vacuum pump is external to the housing, preferably, as in the illustrated arrangement, a connection port of the vacuum pump is communicated with the ducting of the housing at a location downstream from the heat exchanger relative to flow of the heat transfer medium, such that the heat transfer medium passes through the heat exchanger upon evacuation from the housing by the vacuum pump. This acts to permit cooling of the heat transfer medium before passing through the vacuum pump, which may help to preserve the vacuum pump and to reduce energy loss associated with heat carried by the heat transfer medium that would be otherwise lost to the external environment.

Preferably, the phase change material is bitumen.

Preferably, the bitumen is residue collected from vacuum distillation of crude oil. This may be referred to in industry as straight-run bitumen.

Preferably, the thermal battery further includes dampers in the ducting located adjacent the heat transfer assembly relative to flow of the heat transfer medium and configured to selectively isolate the heat exchanger from the thermal core. For example, the dampers may be located upstream and/or downstream of the heat transfer assembly.

Preferably, the dampers are configured to be positioned in an open position relative to the ducting to fluidically intercommunicate the heat exchanger and a portion of the ducting adjacent the thermal core when the heat transfer assembly is in an active state in which the heat transfer medium is circulating and wherein the dampers are configured to be positioned in a closed position relative to the ducting to obstruct the flow of the heat transfer medium, and preferably, additionally, to block thermal radiation, when the heat transfer assembly is in an inactive state in which the heat transfer medium is not circulated.

In the illustrated arrangement, the fluidic pump of the heat transfer assembly comprises a centrifugal-type fan.

In the illustrated arrangement, the fluidic pump of the heat transfer assembly comprises a fan having a plurality of different speeds.

Preferably, the container of the thermal core and the walls of the compartments comprise aluminum. For example, the container and the compartment walls are made of an aluminum alloy.

Preferably, the housing comprises a frame, inner and outer enclosures supported by the frame in spaced relation to each other and thermal insulation between the inner and outer enclosures.

Preferably, walls of the inner and outer enclosures are corrugated.

According to another aspect of the invention there is provided a method of using a thermal battery to store and release thermal energy, the method comprising:
providing a phase change material in an enclosed thermally-conductive container to form a thermal core of the thermal battery;
electrically heating the phase change material of the thermal core to a prescribed temperature;
circulating, within a thermally insulated enclosure of the thermal battery receiving the thermal core, a fluidic heat transfer medium around the thermal core to extract thermal energy therefrom; and conveying the extracted thermal energy outside the thermally insulated enclosure using a heat exchanger of the thermal battery operatively receiving the fluidic heat transfer medium.

This provides an arrangement for extracting thermal energy from a contained phase change material, which can be electrically recharged to replenish the thermal energy extracted therefrom.

Preferably, the phase change material is stored in the container under vacuum conditions.

Preferably, providing the phase change material comprises transferring, for storage in the enclosed thermally-conductive container, the phase change material at the prescribed temperature. Thus, upon cooling of the phase change material after transference to the container, a vacuum is formed. Furthermore, when the phase change material is later heated to the prescribed temperature, the container does not become over-pressurized.

Preferably, the phase change material is bitumen.

When the phase change material is received in compartments formed within the container of the thermal core and when walls of the compartments are thermally-conductive, preferably, electrically heating the phase change material comprises applying electrically-generated heat to the walls of the compartments so as to heat the phase change material received in the compartments.

Preferably, the method further includes:
if a heat transfer assembly operatively connected to the heat exchanger is not operated to transfer the extracted thermal energy outside the enclosure, obstructing flow of the heat transfer medium to thermally isolate the heat exchanger from the thermal core.

Preferably, circulating, within a thermally insulated enclosure receiving the thermal core, a fluidic heat transfer medium comprises blowing air in a circulatory path along which lies the thermal core.

Preferably, the circulatory path is directed from a top to a bottom of the thermal core to be opposite to convectional airflow.

Preferably, a periphery of the thermal core between the top and the bottom also lies along the circulatory path.

In the illustrated arrangement, the method further includes exchanging the fluidic heat transfer medium between an interior of the enclosure and an exterior thereof in response to operation of the heat transfer assembly.

Preferably, exchanging the fluidic heat transfer medium between an interior and exterior of the enclosure in response to operation of the heat transfer assembly comprises:
transferring the fluidic heat transfer medium outside the enclosure to form a vacuum therein for reducing loss of thermal energy when the heat transfer assembly is in an inactive state; and
transferring the fluidic heat transfer medium into the enclosure for circulation around the thermal core when the heat transfer assembly is activated to transfer the extracted thermal energy outside the enclosure after being in the inactive state.

When the fluidic heat transfer medium is air, preferably, the fluidic heat transfer medium is exchanged between an interior of the enclosure and an ambient environment thereof.

In the illustrated arrangement, the fluidic heat transfer medium is guided past the heat exchanger during evacuation from the interior of the enclosure to the exterior thereof.

### BRIEF DESCRIPTION OF THE DRAWINGS

The invention will now be described in conjunction with the accompanying drawings in which:

FIG. 1 is a bottom perspective view of an arrangement of thermal battery according to the present invention;

FIG. 2 is a cross-sectional view along plane 2-2 in FIG. 1;

FIG. 3 is a cross-sectional view along plane 3-3 in FIG. 5;

FIG. 4 is an enlarged partial view of an area indicated at I in FIG. 3;

FIG. 5 is a perspective view of a thermal core of the arrangement of thermal battery of FIG. 1;

FIG. 6 is a cross-sectional view along line 6-6 in FIG. 2;

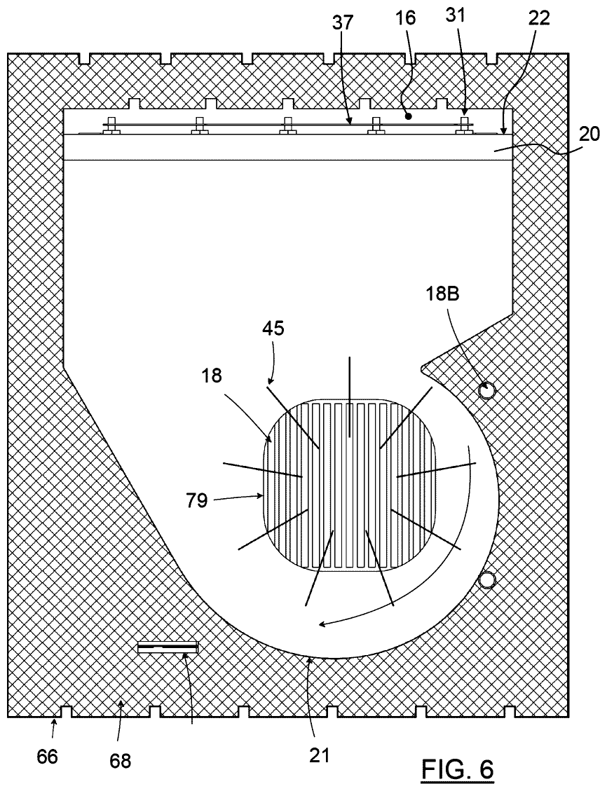

FIG. 7 is a perspective view of a frame of a housing of the arrangement of thermal battery of FIG. 1; and

FIG. 8 is a cross-sectional view along plane 8-8 in FIG. 1.

In the drawings like characters of reference indicate corresponding parts in the different figures.

### DETAILED DESCRIPTION

The accompanying figures show a thermal battery generally indicated at reference numeral 10 which is particularly but not exclusively suited for use in an electric vehicle.

Generally speaking, the thermal battery 10 comprises a thermal core 12 configured to store and release thermal energy; a housing 15 having an enclosed interior 16 receiving the thermal core 12 therein; and a heat transfer assembly 18 inside the housing 15 and comprising a fluidic pump 18A configured to circulate a fluidic heat transfer medium 19 in the housing interior 16 for extracting the thermal energy from the thermal core 12 and a heat exchanger 18B configured to extract the thermal energy from the heat transfer medium for release outside the thermal battery. The heat exchanger 18B includes connection ports 18C supported at an exterior of the housing 15 and configured for connection to an external heat transfer assembly including a heat transfer loop 18D disposed outside the housing 15. The external heat transfer assembly, which includes the loop 18D, is configured for circulating a distinct heat transfer medium to convey the extracted thermal energy to an application A external to the thermal battery, for example an electric vehicle.

The housing interior 16 forms ducting around the thermal core 12 and between the thermal core and the heat transfer assembly 18 for conveying the fluidic heat transfer medium 19 across outer surfaces 20 of the thermal core to extract the thermal energy therefrom. That is, the housing 15 has interior walls 21 which are shaped to form passageways for guiding the fluidic transfer medium 19 through the heat transfer assembly 18, which is in the housing interior 16. Furthermore, it will be appreciated that in the illustrated arrangement the housing 15 is fluidically sealed so as to resist exchange of the fluidic heat transfer medium 19 between the housing interior 16 and an exterior environment of the housing, which is an ambient environment of the thermal battery.

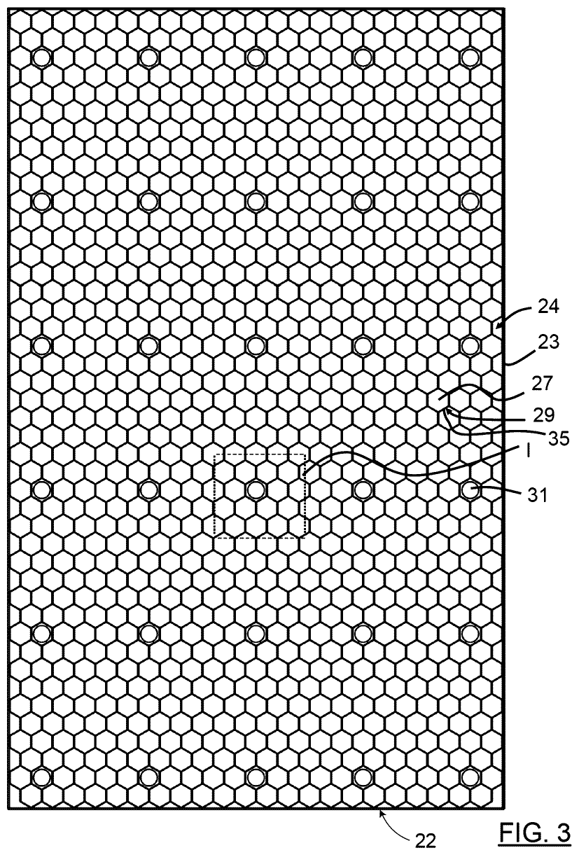

In order to provide the thermal energy for extraction, the thermal core 12 comprises a container 22 having peripheral walls 23 forming a core interior 24 (shown more clearly in FIG. 3) distinct from the interior 16 of the housing; phase change material 27 received in the core interior 24 and configured to store and release the thermal energy; an array of compartments 29 in the container dividing the core interior 24 into a plurality of substantially separate volumes receiving the phase change material 27; and a plurality of heating devices 31 supported in the core interior 24 and in thermal contact with the array of compartments. In the illustrated arrangement, the phase change material 27 is in a liquid state, so as to be between its freezing and evaporating points, during a portion of use or operation of the thermal battery and in a solid state during a portion thereof. It will be appreciated that when the phase change material 27 is in the solid state, both latent and sensible heats are extracted or captured therefrom. Additionally, in the illustrated arrangement, the phase change material 27 is bitumen, specifically that which is residue collected from vacuum distillation of crude oil, which may be referred to in industry as straight-run bitumen. Thus, the phase change material is economically available and provides a suitable specific heat capacity.

It will be appreciated that the volumes of the compartments are substantially separate from each other in that a total volume of all of the compartments is substantially equal to a volume of the core interior 24, with the exception of a void 33 provided in the core interior 24 that acts as a manifold to fluidically intercommunicate the compartments as to enable filling of all compartments by a single common fill port.

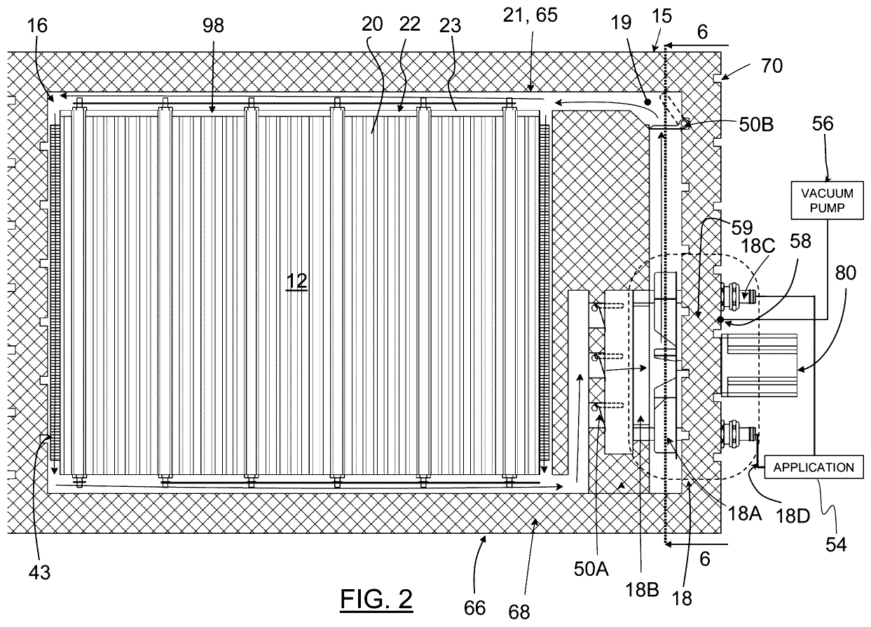

The peripheral walls 23 of the container define the outer surfaces 20 of the thermal core 12 across which the heat transfer medium 19 is conveyed, which is more clearly shown in FIG. 2. Accordingly, to facilitate extraction of heat at the outer surfaces, the peripheral walls 23 are thermally conductive, for example by being made of thermally conductive material.

To convey the thermal energy internal to the container 22 and to the peripheral walls 23, the compartments 29 receiving the phase change material 27 have walls 35 defining the substantially separate volumes and which are thermally conductive, for example by being made of thermally conductive material. The compartments 29 are thermally interconnected, that is each with the other, to transmit thermal energy between the substantially separate volumes. Furthermore, the array of compartments 29 is thermally connected to the peripheral walls 23 of the container to transmit thermal energy thereto. In the illustrated arrangement, the thermal connections are by directly attaching thermally conductive material to each other, for example by welding or brazing.

In the illustrated arrangement, the container 22 of the thermal core 12 and the walls 35 of the compartments 29 comprise aluminum. For example, the container and the compartment walls are made of an aluminum alloy.

To transfer energy from an external source and to the phase change material 27, there are provided the heating devices 31 which are configured to apply thermal energy to the phase change material 27 for storage therein. The heating devices 31 are electrical heating devices which are electrically connected to an external electrical power source, that is an electrical power source external to the thermal battery and not considered constituent to same. In this manner, when the thermal battery is used in an electric vehicle, the thermal battery can be recharged at the same time as recharging the traction battery. The thermal battery can also be used as electric braking mechanism by capturing extra kinetic energy of the vehicle converted into electricity by regenerative braking of an electric vehicle when the traction battery cannot accept this energy. This will improve braking power while increasing the life of mechanical brakes.

In the illustrated arrangement, the core container 22 is rectangular prismatic in shape and the compartments 29 extend linearly along respective parallel axes A within the container 22. The compartments 29 span a first one of the dimensions (length, width or height) of the container. More specifically, in the illustrated arrangement, the compartments 29 span the height of the container between generally horizontally-oriented and vertically spaced-apart pair of the peripheral walls 23A.

In the illustrated arrangement, the compartments 29 are formed by a lattice structure supported in the container, which is in the shape of a honeycomb grid in which each of the compartments 29 has a hexagonal cross-section. In the lattice structure, each row of the compartments is staggered relative to the next so as to act to reinforce the peripheral walls 23 of the core. The lattice structure is mechanically connected at one of two opposite open ends to the container 23 surrounding the lattice structure. A linear dimension of the lattice structure between the opposite open ends thereof is slightly less than a corresponding dimension of the core container 22, so as to form a gap 33 between one of the open ends of the lattice structure which is detached from the container and a proximal one of the container walls 23 in opposite relation to this end of the lattice structure to provide fluidic intercommunication between the compartments.

For satisfactory heating of the phase change material 27 within a full interior 24 of the core container 22, the electric heating devices 31 are in the form of rods which are cylindrical and spanning a corresponding one of the dimensions in which the compartments 29 span within the container 22, in this case the height of the container. Furthermore, the heating devices 31 protrude beyond the peripheral walls 23 of the container into the interior of the battery housing 16 so as to be presented for electrical connection to the external source. More specifically, the heating devices protrude on opposite sides of the core container, in this case the top and the bottom thereof, and electrical interconnection is provided at both ends of the heating devices. In the illustrated arrangement, the electric heating devices 31 are electrically connected in parallel to bus bars 37 which carry electrical power thereto.

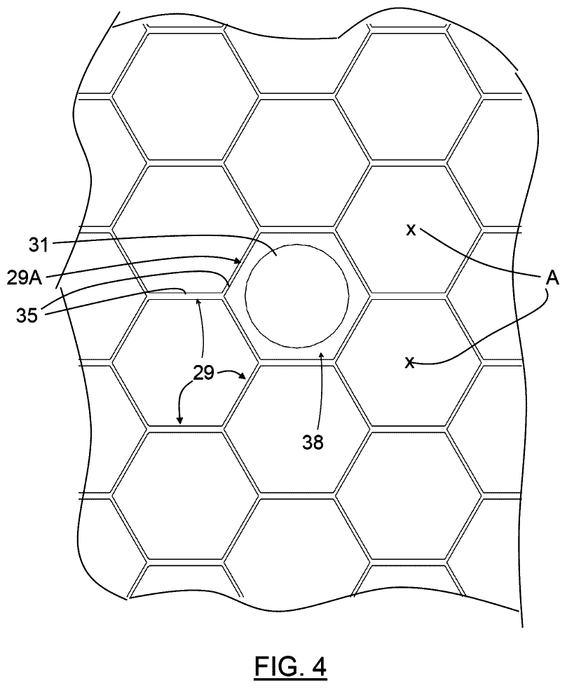

Referring back to FIG. 4, the heating devices 31 are received in select ones of the compartments 29A which are free of phase change material 27. To bridge between the heating devices and the walls 35 of the select compartments 29A receiving the same, which are of different transverse dimension relative to the dimension of the container in which both the heating devices and compartments span, each heating device 31 is thermally connected thereto by a thermally conductive body 38 mechanically interconnecting the heating device to the compartment walls. These bodies 38 are in the form of tubular sleeves thermally connected to the heating devices and to the walls of the surrounding compartments, which have an inner cross-section substantially corresponding to the heating devices, which are circular cylindrical in shape in the illustrated arrangement, and an outer cross-section substantially corresponding to the compartments which is hexagonal cylindrical in shape.

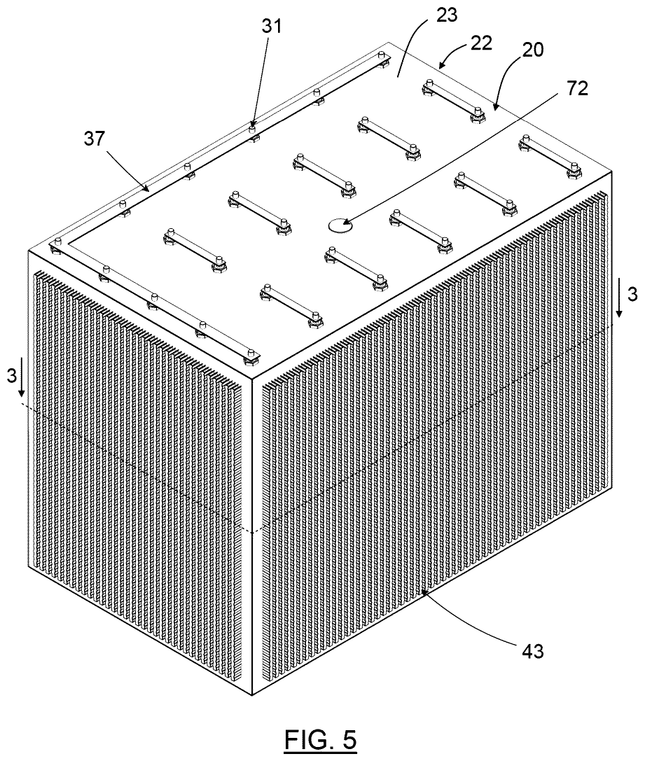

Referring back to FIG. 5, to improve heat extraction from the container 22, the thermal core 12 further includes thermally conductive fins 43 supported in upstanding relation from the outer surfaces 20 of the container and thermally connected to the peripheral walls 23 of the container. In the illustrated arrangement, the fins 43 follow wavy paths across the peripheral walls and extending parallel to directions of flow of the heat transfer medium across the outer surfaces 20 so as not to substantially impede the flow of the heat transfer medium within the housing's ducting. Furthermore, in the illustrated arrangement, the heat extraction fins are provided on sides of the container which do not carry the ends of the heating devices, so as not to interfere with electrical connections. In the illustrated arrangement, the sides free of electrical connections for the heating devices are the horizontally-facing sides of the container. Thus, the top and the bottom faces of the container 22 are free of the fins.

As more clearly shown in FIG. 2, to optimize heat extraction from the thermal core, all the peripheral walls 23 of the core container 22 are in spaced relation to the interior walls 21 of the housing defining the interior 16 thereof and forming the ducting around the core 12. Thus, ducting is provided around the entire container so that the heat transfer medium 19 is enabled to flow across all sides of the core's container, in this case all six sides as the container is rectangular prismatic in shape.

The heat transfer medium 19 is conduced to move within the housing interior 16, that is the ducting, by a fluidic pump 18A of the heat transfer assembly 18 which is configured to displace the fluidic heat transfer medium. In the illustrated arrangement, the heat transfer medium is gaseous, and the fluidic pump is a fan or blower having a plurality of blades supported for movement in a rotary path. More specifically, the fan is a centrifugal-type fan and has a plurality of different speeds for varying rate of heat extraction from the core and accordingly an output temperature of the thermal battery. Preferably, the fan is operated at low rotational speed when the core is hot and at high rotational speed when the core is cooler in temperature, so that an output temperature of the battery may remain substantially constant.

As more clearly shown in FIG. 2 where arrows within the ducting 16 show flow of the heat transfer medium 19, In the illustrated arrangement, the heat transfer assembly 18 is configured to circulate the heat transfer medium 19 about the thermal core 12 from the top to the bottom thereof. As such, the direction of forced flow of the heat transfer medium is opposite to a direction in which the heat transfer medium may naturally circulate due to convection, since heating of the heat transfer medium occurs around the thermal core and cooling at the heat exchanger 18B.

The thermal battery further includes dampers 50A and 50B in the ducting located adjacent, and preferably both upstream and downstream, of the heat transfer assembly 18 relative to the flow of the heat transfer medium 19 and configured to selectively isolate the heat transfer assembly 18, and particularly the heat exchanger 18B thereof, from the thermal core 12. The dampers 50A, 50B are configured to be positioned in an open position relative to the ducting 16 (schematically shown in phantom in FIG. 2) to fluidically intercommunicate the heat transfer assembly 18, and particularly the heat exchanger 18B thereof, and a portion of the ducting adjacent the thermal core 22, when the heat transfer assembly 18 is in an active state in which the heat transfer medium is circulating. Additionally, the dampers are configured to be positioned in a closed position relative to the ducting, as shown in solid line in FIG. 2, to obstruct the flow of the heat transfer medium when the heat transfer assembly 18 is in an inactive state in which the heat transfer medium is not circulated.

To allow maximum heat extraction from the core 12, the application A preferably includes a heat pump operatively connected to the heat transfer loop 18D. The heat pump is thus disposed externally of the housing 15 and configured to be actuated to extract thermal energy from the heat transfer medium 19 when a temperature of the heat transfer medium is below a prescribed threshold temperature. In the illustrated arrangement, the prescribed threshold temperature is in a range between about 60° C. and about 80° C., when the bitumen phase change material transitions from liquid state to solid state so as to solidify. This may increase a usable range of temperatures of the phase change material across which thermal energy is extractable by allowing drainage of thermal energy from the thermal core 12 in such a manner as to bring the temperature of the thermal core to as low as about 0° C. with common automotive refrigerants while consistently delivering hot air to the electric vehicle cabin.

To reduce heat loss when the heat exchanger is in the inactive state, the thermal battery 12 further includes a vacuum pump 56 in fluidic communication with the interior 16 of the housing and the exterior or ambient environment of the housing. The vacuum pump 56 is configured to (i) release the fluidic heat transfer medium 19 to the exterior environment of the housing, so as to form a vacuum pressure in the interior 16 of the housing, when the heat transfer assembly 18 is in an inactive state in which the heat transfer medium is not circulated, and (ii) admit the fluidic heat transfer medium 19 to the interior 16 of the housing from the exterior environment, when the heat transfer assembly 18 is activated from the inactive state to circulate the heat transfer medium 19. In the illustrated arrangement, the vacuum pump 56 is external of the housing 15 and a connection port 58 of the vacuum pump 56 is communicated with the ducting of the housing at a location downstream from the heat exchanger 18B relative to the flow of the heat transfer medium 19, such that the heat transfer medium passes through the heat exchanger 18B upon evacuation from the housing 15 by the vacuum pump 56. This acts to permit cooling of the heat transfer medium 19 before passing through the vacuum pump, which may help to preserve the vacuum pump and to reduce energy loss associated with heat in the heat transfer medium 19 that would be otherwise lost to the external environment.

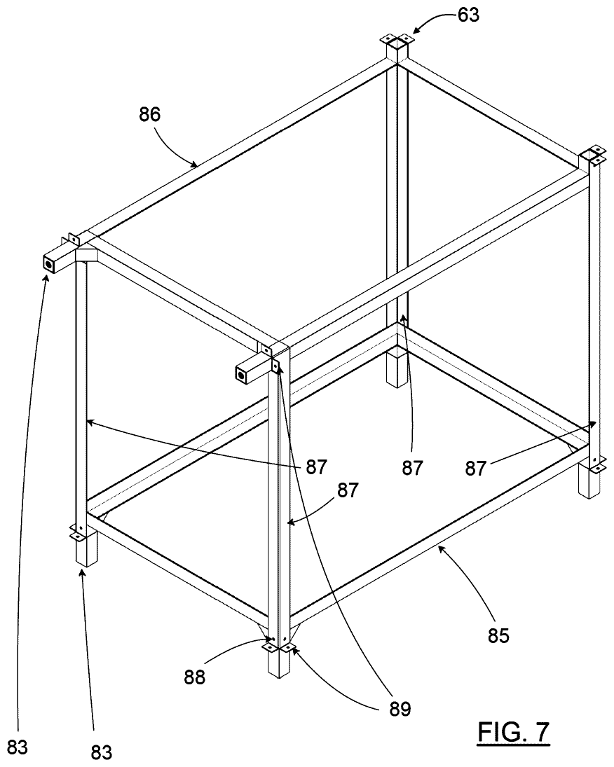

To further reduce heat loss from the thermal core 12, the housing 15 is thermally insulated to passively resist heat loss. More specifically, and as shown in FIGS. 2 and 7, the housing 15 comprises a frame 63, inner and outer enclosures 65, 66 supported by the frame 63 in spaced relation to each other and thermal insulation 68 between the inner and outer enclosures. At least select ones of the walls of the inner and outer enclosures, which are indicated at 21 for the inner enclosure and 70 for the outer enclosure, are corrugated to strengthen the housing, and preferably all of the walls are corrugated. The walls 21 of the inner enclosure 65 at least partially form the ducting and the housing interior 16.

This provides an arrangement to efficiently store thermal energy in a phase change material and to extract such energy therefrom.

There is also disclosed herein a method of using a thermal battery 10 to store and release thermal energy. This generally comprises the steps of:
providing a phase change material 27 in an enclosed thermally-conductive container 22 to form a thermal core 12 of the thermal battery 10;
electrically heating, such as via heating devices 31, the phase change material 27 of the thermal core to a prescribed temperature;
circulating, within a thermally insulated enclosure 15 of the thermal battery receiving the thermal core 12, such as via fluidic pump 18A, a fluidic heat transfer medium 19 around the thermal core 12 to extract thermal energy therefrom; and conveying the extracted thermal energy outside the thermally insulated enclosure using a heat exchanger 18B of the thermal battery operatively receiving the fluidic heat transfer medium.

The heat exchanger 18B operatively receives the heat transfer medium 19 in that the medium 19 passes by or through the heat exchanger 18B in a manner to interface therewith such that heat or thermal energy is extracted from the medium.

In the illustrated arrangement, the fluidic heat transfer medium and the phase change material are in different physical states, namely gaseous, and liquid or solid, respectively.

It will be appreciated that the fluidic heat transfer medium 19 is contained separately from the phase change material 27. In the illustrated arrangement, the fluidic heat transfer medium 19 is guided around an outside of the container 22 receiving the phase change material and not through the same, so as to flow past and in physical contact with the outer surfaces of the container 22.

The step of providing the phase change material 27 comprises transferring, for storage in the enclosed thermally-conductive container 22, the phase change material at the prescribed temperature. In the illustrated arrangement, the prescribed temperature is the maximum operating temperature of the phase change material 27, and which considers a material of the container; in the case of bitumen as a phase change material contained in an aluminum alloy container, the prescribed temperature is 400° C. Thus, upon cooling of the phase change material 27 after transference to the container, a vacuum is formed, such that the phase change material 27 is stored in the container under vacuum conditions. Furthermore, when the phase change material 27 is later heated to the prescribed temperature, the container does not become over-pressurized.

In the illustrated arrangement, the phase change material 27 is transferred through an access port 72 in an upper wall of the container 22 defining the top thereof. After transferring into the container 22, the port 72 is permanently affixed in a closed position to fluidically seal the container interior 24 thereat.

When the phase change material 27 is received in compartments 29 formed within the container 22 of the thermal core and when the walls 35 of the compartments are thermally-conductive, the step of electrically heating the phase change material 27 comprises applying electrically-generated heat to the walls 35 of the compartments 29 so as to heat the phase change material 27 received in the compartments 29.

In the illustrated arrangement, the step of circulating the fluidic heat transfer medium 19 comprises blowing air in a circulatory path along which lies the thermal core 12. That is, in the illustrated arrangement, air is the heat transfer medium 19. Furthermore, in the illustrated arrangement, the circulatory path is directed from the top to the bottom of the thermal core to be opposite to convectional airflow, and a periphery of the thermal core between the top and the bottom also lies along the circulatory path. As such, all sides of the core's container, including the top and the bottom and those which face horizontally outwardly, receive the fluidic heat transfer medium 19 circulated past the core 12.

To reduce heat loss, there may be provided a step of obstructing flow of the heat transfer medium 19 to thermally isolate the heat exchanger from the thermal core if a heat transfer assembly operatively connected to the heat exchanger 18B, which generally is an external heat transfer assembly including the loop 18D, is not operated to transfer the extracted thermal energy outside the enclosure.

To assist in reducing heat loss in a different manner than isolating the heat exchanger 18B from the core 12, there is provided a step of exchanging the fluidic heat transfer medium 19 between the interior 16 of the enclosure 15 and an exterior thereof in response to operation of the heat transfer assembly operatively connected to the heat exchanger 18B to convey the extracted thermal energy outside the enclosure. More specifically, this comprises transferring the fluidic heat transfer medium 19 outside the enclosure 15 to form a vacuum therein for reducing loss of thermal energy when the heat transfer assembly 18 is in an inactive state, and transferring the fluidic heat transfer medium 19 into the enclosure 15 for circulation around the thermal core 12 when the heat transfer assembly 18 is activated to transfer the extracted thermal energy outside the enclosure after being in the inactive state.

When the fluidic heat transfer medium 19 is air, as in the illustrated arrangement, the fluidic heat transfer medium 19 is exchanged between the interior of the enclosure and the ambient environment thereof. To reduce loss of heat stored in the heat transfer medium 19 when the medium is transferred to the ambient environment, that is during evacuation from the interior of the enclosure and to the exterior thereof, the fluidic heat transfer medium is guided past the heat exchanger 18B.

This provides an arrangement for extracting thermal energy from a contained phase change material, which can be electrically recharged to replenish the thermal energy extracted therefrom.

As described hereinbefore, the thermal battery of the illustrated arrangement uses bitumen as a phase change material. Bitumen has certain desirable thermophysical properties for heat storage:
High latent heat of fusion (˜400 KJ/kg).
High average sensible heat capacity (˜3.5 KJ/kgK on average within 40° C. to 400° C. range).
Compared to other phase change materials such as paraffin wax, bitumen has a high heat capacity and is significantly less expensive.
High boiling point (>525° C.)
Specific heat capacity calculation:

$$Latent heat = 400 \text{kJ/kg}$$

Average Sensible heat=3.5 KJ/kgK times 360 K=1260 KJ/kg

Thus, the specific heat capacity for bitumen heated to 400° C. and cooled to a solid at 40° C. is around (400+1260)=1660 KJ/kg. Thus, using bitumen, more thermal energy can be stored using less mass and at relatively low cost considering bitumen is an abundant organic and natural material.

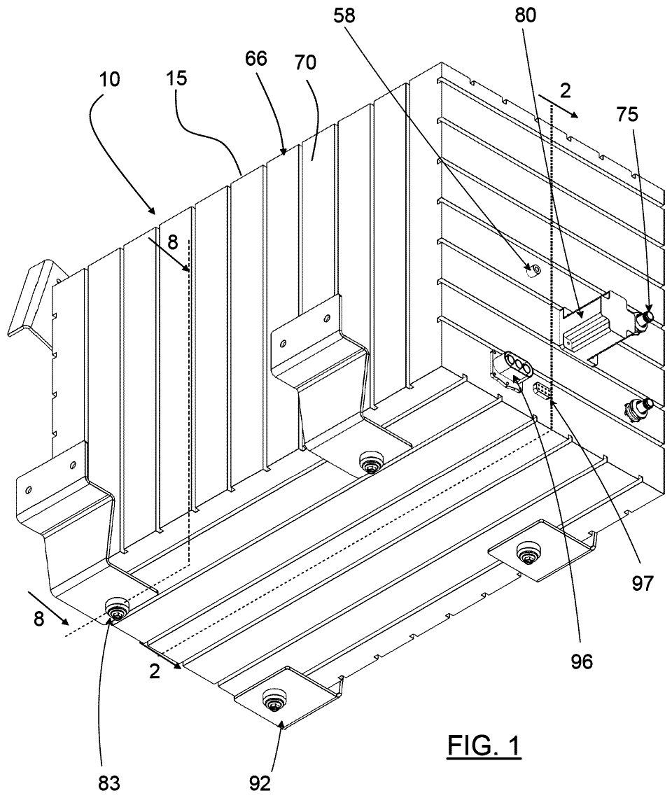

At a suggested volume of 216 L, and the density of liquid bitumen being 725 kg/m3 at the limit temperature of 400° C., and the porosity of the honeycomb lattice is around 94% (depending on dimensions), and the 30 heating elements take up 30/1012 cells=3% (see FIG. 1) so the total mass of bitumen is 216 L*. 725 kg/L*0.94*0.97=143 kg in the illustrated arrangement. This gives a total heat capacity of 143 kg*1660 KJ/kg=237380 KJ or 66 kWh. This is enough to continuously heat a large cabin of a commercial truck for over 13 hours during a cold (−40° C.) winter day (5 KW power requirement assumption).

Bitumen has certain challenges, namely low thermal conductivity (around 0.075 W/mK as a liquid). Thus, the bitumen is poured into an aluminum honeycomb lattice (see FIG. 1) so that thermal conductivity is no longer a problem. The honeycomb is fully welded or brazed to be suitable for high temperatures and improve the thermal conductivity when bitumen is heated by electric heat elements at high rates or allows the thermal battery to be so called fast charged. Common aluminum honeycomb is made with an adhesive and is not suitable for high temperatures. Laser welding is a preferred technique for manufacturing the aluminum honeycomb lattice.

The bitumen is limited to operating at a maximum temperature of 400° C. is because aluminum drastically loses its mechanical properties at higher temperatures.

The bitumen, in liquid physical state, is poured hot into the honeycomb lattice at the limiting temperature through a fill port and this port, after vacuuming out any air in the core, is immediately welded shut. As the material cools, it will shrink and forms a stronger vacuum inside the core, so that it has room to expand again once it is heated without pressurizing the core causing leaks or damages. The honeycomb reinforces the outer aluminum sheets against the inward vacuum pressure. In another arrangement, the core may have a breather with the ambient pressure and Bitumen could be poured at a temperature high enough for pouring (e.g. 150° C.).

The electric heating elements 31 (of which there are 30 in the illustrated arrangement) are inserted into the honeycomb lattice, which is the assembly of walls 35 forming the compartments 29, and furthermore inside an aluminum hexagonal extruded profile 38 that is welded into the honeycomb lattice. When the thermal battery 10 is implemented in an electric vehicle, the process of thermally charging (heating) the thermal battery 10 happens at the charging station concurrently with electrically charging the traction battery. Preferably, the thermal battery is also electronically connected to the traction battery pack and can generate heat as long as the battery pack has energy stored or can store all or part of the energy generated by the regenerative braking system.

The honeycomb lattice forming the compartments 29 (spacing and material thickness) is configured to conduct enough heat throughout the bitumen while maximizing porosity (minimizing total mass of aluminum relative to bitumen). In the illustrated arrangement, the dimensions are 20 mm spacing, and a 0.5 mm material thickness, resulting in a porosity of 94%. In this manner, the thermal battery may be electrically thermally charged or heated quickly and in a manner not impeding charging rate of the traction battery of an electric vehicle which is electrically charged relatively quickly. For other applications like residential building heating, the mass and thickness of the lattice material may be considerably lower, providing higher porosity and lower cost.

The phase change material 27 is fully chargeable from cold in under one hour without overheating the aluminum lattice. Peak charging power of well over 100 KW can be achieved for short durations, allowing the regenerative brakes to dump energy in the thermal battery in the scenario that the traction battery is nearly full or not able to take the excess charge due to temperature or other considerations.

The process of discharging (using the stored heat) is by blowing air over the core 12. The air is heated as it travels from top to bottom and along the four sides. The fins 43 increase heat transfer. The hot air travels through a heat exchanger 18B and heats the coolant loop thereof 18D.

When the core temperature attains a prescribed lower threshold, typically about 60° C. to 80° C. (relative to a prescribed temperature of 400° C.), a heat pump may be operated, in operative cooperation with the coolant loop 18D, to ensure a destination of the extracted thermal energy, such as an occupant cabin of the electric vehicle, is receiving high temperature coolant. This allows the core 12 to be drained all the way to about 0° C.

The illustrated arrangement of thermal battery has wavy fins 43 but other geometries may be used in the alternative.

The housing or enclosure 15 containing the core 12 is well-insulated with high-temperature rated insulation such as mineral wool. Incorporating reflective surfaces, vacuum, and multiple layers of insulation may further reduce heat losses.

The battery 10 may also include the vacuum pump 56 to pull a vacuum on the entire enclosure 15 including the insulation to further reduce heat loss. The air, which is the heat transfer medium 19, will be allowed back in, from the ambient environment, when it is needed to extract heat. The air will be removed when it is not being used to further reduce energy loss. Accordingly, the outer enclosure 66 is sealed and structural to withstand vacuum pressure. However, the inner sheet metal layer 21 is not airtight, so that both the insulation air pockets and the air around the core 12 can be evacuated together.

As shown in FIGS. 3 and 4, the heating element 31 which is round in (transverse) cross-section is inserted into the extruded aluminum profile 38 which is hexagonal and which is welded into the honeycomb lattice. The wall thickness of the lattice is doubled along the seams running up and down, that is vertically, because at these locations there are provided two sheets of the constituent material of the lattice, namely aluminum, to form the lattice.

Bus bars 37 for electrically connecting the heating devices 31 to an external electrical power source are fastened to the heating elements 31 with nuts outside the core 12. The bus bars 37 are configured to receive three-phase AC power or DC power.

The heat exchanger 18B comprises a coolant having a prescribed ratio of 50-50 or 60-40 ethylene glycol-water mix (conventional automotive coolant), which should not be heated above roughly 100° C. During operation, the coolant is pumped through the heat exchanger 18B, and the fan 18A is activated to provide enough airflow to adequately heat the coolant according to the requirements of the application A. When the system is sitting idle (not discharging but still hot), the coolant is still inside the heat exchanger 18B but not being actively pumped, so the radiator is thermally insulated from the core 12 as much as possible, in this case by a thickness of insulation disposed intermediate the heat exchanger 18B and the core to form an insulated wall or barrier, therebetween as shown in FIG. 2 to prevent overheating of the stationary coolant.

The thermal battery also includes flaps 50A, 50B (which may be referred to as backdraft dampers) before the heat exchanger 18B, that is upstream thereof relative to the airflow within the housing, and after the fan 18A, that is downstream therefrom relative to the direction of airflow, to further isolate the heat exchanger 18B from the core 12. The flaps 50A, 50B open when the fan turns and provides airflow, then the flaps close under gravity (and/or biasing elements such as coil springs) when the airflow ceases so that the heat exchanger 18B becomes isolated. These flaps minimize natural convection from the core to the heat exchanger as well as transmission of thermal radiation.

Arrows indicate airflow through heat exchanger, fan, over the top of the core, around the four sides carrying fins 43, and back to the heat exchanger. Based on the configuration of the interior of the battery, natural convection would occur in the opposite direction, and is instead blocked by the flaps, which only allow air flow in one direction.

The fan 18A is housed or disposed inside a duct resembling a blower scroll to redirect the air upwards and minimize pressure losses in the air circuit. The heat exchanger 18B is located inside the wall at an intake 79 of the fan just behind a sheet that blocks corners. That is, a cross-sectional shape of the inlet is rectangular square to receive the heat exchanger which is square in shape; however, to correspond to the circular cross-sectional shape of the fan, corners of the square inlet are obstructed. A drive motor 80 of the fan 18A is mounted to the housing 15 externally thereof and is configured to drive rotation of the fan.

A geometry of the fan 18A, that is a size and a shape and a blade configuration thereof, is optimized for flow characteristics of a closed loop formed by ducting 16 of the housing. That is, during circulation of the heat transfer medium 19, the housing is fluidically closed so that a volume of the heat transfer medium 19 therein is constant. A rotational speed of the fan is varied according to the heating demand and the temperature of the core 12, for example, low air flow is needed when the core 12 is at 400° C., but higher flows are needed as it cools. It will be appreciated that the fan speed and the external coolant pump speed controls the heat output.

In the illustrated arrangement, a mounting cage 63 of the housing, that is a frame thereof, is made of stainless steel, which is a substantially thermally insulating material compared to other metals, and is affixed to the core 12 for example by riveting or welding to permanently brace the core on all sides. Furthermore, the frame 63 has mounting locations 83 to be fastened to an external support structure, for example a frame or chassis of a self-propelled land vehicle. More specifically, in the illustrated arrangement, the frame 63 includes threaded inserts for mounting at six locations (a plurality, specifically four, at an underside of the frame 63 and a plurality, specifically two, on one horizontally-facing side thereof, such as a back side). In the illustrated arrangement, the frame comprises a rectangular prismatic framework including a substantially horizontally-oriented annular lower frame portion 85, a substantially horizontally-oriented annular upper frame portion 86, and a generally vertically extending interconnecting frame portion 87. The lower and upper frame portions form shoulders which are oriented to face each other, so as to act to retain the core located therebetween. During manufacturing, initially the lower or bottom frame 85 is placed in a working orientation, then the core 12 is placed on top, after which the top frame 86 is laid on top of the core 12, and thereafter four lower corners of the core are fastened to the bottom frame, for example by riveting, at locations 88 to secure the core in between.

The enclosure 15 comprises two layers of sheet metal: an outer layer 66 and an inner layer 65, with insulation 68 therebetween. The inner and outer enclosures 65, 66 are made of substantially thermally insulating (non-conductive) material, such as stainless steel, for strength, corrosion resistance, and low thermal conductivity. The outer layer 66 is fastened to the external supporting structure by the mounting bolts and may also be supported to the inner layer 65 at other points if necessary. The inner layer 65 is fastened to the frame via tabs 89 supported on the top and bottom frame portions, which are normally to adjacent surfaces of the frames carrying the same. Auxiliary supports comprising electrically insulating material may be provided along the top and/or bottom of the core to prevent the sheet metal contacting the bus bars 37, causing electrical short circuit currents to flow to the chassis.

Mounting locations on the core 12 which attach to the enclosure are free of heat-extracting fins, namely the top and the bottom thereof.

The bus bars 37 that run toward the outside are covered with a high temperature rated electrical insulation such as ceramic fabric.

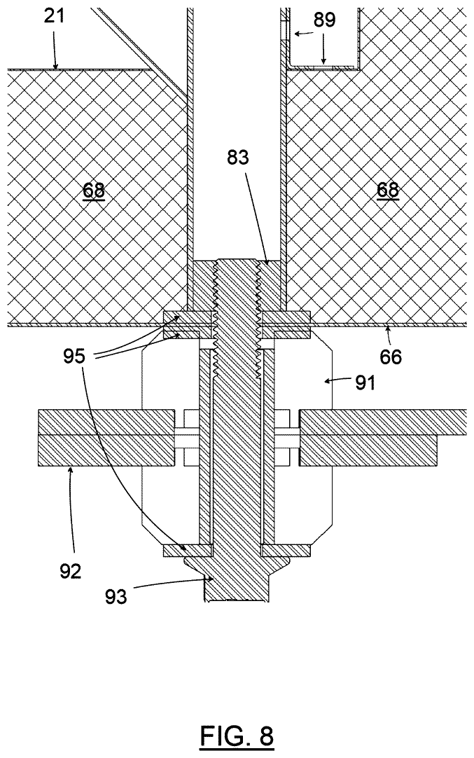

FIG. 8 shows an example of a configuration for attaching the battery by its housing 15 to an external support structure. When the support structure is a vehicle so as to be movable or mobile, rubber mounting 91 is used for vibration dampening. The rubber mount 91 is disposed around a mounting bracket 92 with a mounting bolt 93 fastening this to the threaded insert 83. The outer layer 66 is sandwiched between washers 95 provided in a pair which is disposed between the mounting insert and the rubber mount. All the fasteners, washers, and rubber mount sleeve are made of substantially thermally non-conductive material such as stainless steel for reduced thermal bridging.

All penetrations for externals (3-phase connector indicated at 96 and low voltage connector indicated at 97, fan motor 80, 2 coolant pipes 18C), that is openings in the housing 15 for connection to external devices relative to the thermal battery, are provided on a common side of the housing 15 which is distal to the core 12 within the housing 15 and disposed closer to one side relative to one of the dimensions, which in this case is the front face of the housing. The front face is nearest to the fan 18A and heat exchanger 18B. This is because this face is coolest among all faces so there is lowest thermal bridging associated with these penetrations. The major insulated barriers and flaps allow the heat exchanger 18B to stay cool enough (under 100° C.) even under core temperature of 400° C. The fan blade 18A and motor 80 are joined by a shaft that penetrates through this face.

Walls of the outer and inner layers, that is the outer and inner enclosures 66, 65 of the housing, are corrugated to increase rigidity. This can be done by a variety of manufacturing methods like bending, stamping or rolling.

The vacuum pump 56 has a single port 58 where it connects through the outer layer 66. This port should be located on the front face just like the other penetrations, in order to encourage the air to travel through the heat exchanger 18B on the way to the vacuum pump so as not to suck hot air through the pump 56 and damage it. A port such as that indicated at 58, which fluidically intercommunicates the ducting and the external environment of the housing 15, may be provided in an alternative arrangement thermal battery without vacuum pump to provide breathing of the thermal battery, that is pressure equalization between the interior and exterior of the thermal battery.

As described hereinbefore, the present invention relates to a thermal battery comprising a thermal core configured to store and release thermal energy, a housing having an enclosed interior receiving the thermal core therein and a heat exchanger inside the housing and configured to (i) circulate a heat transfer medium around the core and (ii) extract thermal energy from the heat transfer medium for release outside the thermal battery. Ducting inside the housing fluidically interconnects the heat exchanger and a space around the core. The core comprises an enclosed container with thermally conductive outer walls, a phase change material received therein, an array of compartments defining substantially separate volumes receiving the phase change material and thermally connected to the outer walls of the container, and heating devices in the core and in thermal contact with the compartments for heating the phase change material.

The scope of the claims should not be limited by the preferred embodiments set forth in the examples but should be given the broadest interpretation consistent with the specification as a whole.

1. A thermal battery comprising:
a thermal core configured to store and release thermal energy;
a housing having an enclosed interior receiving the thermal core therein;
a heat transfer assembly inside the housing, wherein the heat transfer assembly comprises a fluidic pump configured to circulate a fluidic heat transfer medium in the interior of the housing for extracting the thermal energy from the thermal core and a heat exchanger configured to extract the thermal energy from the heat transfer medium for release outside the thermal battery;
wherein the interior forms ducting around the thermal core and between the thermal core and the heat transfer assembly for conveying the heat transfer medium across outer surfaces of the thermal core to extract the thermal energy therefrom;
wherein the thermal core comprises:
a container having peripheral walls forming a core interior distinct from the interior of the housing, wherein the peripheral walls define the outer surfaces of the thermal core across which the heat transfer medium is conveyed, wherein the peripheral walls are thermally conductive;
phase change material received in the core interior and configured to store and release the thermal energy;
an array of compartments in the container dividing the core interior into a plurality of substantially separate volumes receiving the phase change material, wherein the compartments have walls defining the substantially separate volumes and which are thermally conductive, wherein the compartments are thermally interconnected to transmit thermal energy between the substantially separate volumes, wherein the array of compartments is thermally connected to the peripheral walls of the container to transmit thermal energy thereto; and
a plurality of heating devices supported in the core interior and in thermal contact with the array of compartments, wherein the heating devices are configured to apply thermal energy to the phase change material for storage therein.

2. The thermal battery of claim 1 wherein the heating devices are received in select ones of the compartments which are free of the phase change material.

3. The thermal battery of claim 2 wherein each one of the heating devices is thermally connected to the walls of a corresponding one of the compartments receiving the heating device by a thermally conductive body mechanically interconnecting the heating device and the walls of the compartment.

4. The thermal battery of claim 1 wherein the compartments extend linearly along respective parallel axes within the container.

5. The thermal battery of claim 4 wherein, when the container is rectangular prismatic in shape, the compartments span a first one of the dimensions of the container.

6. The thermal battery of claim 5 wherein the compartments span the first dimension of the container between generally horizontally-oriented and vertically spaced-apart pair of the peripheral walls.

7. The thermal battery of claim 1 wherein, when the container is rectangular prismatic in shape and when the compartments extend linearly along respective parallel axes within the container oriented along one of the dimensions of the container, the heating devices span said one of the dimensions and protrude beyond the peripheral walls of the container into the interior of the housing.

8. The thermal battery of claim 1 wherein the compartments are formed by a lattice structure supported in the container of the thermal core.

9. The thermal battery of claim 1 wherein all of the peripheral walls of the container of the thermal core are in spaced relation to walls of the housing defining the interior thereof.

10. The thermal battery of claim 1 wherein the thermal core further includes thermally conductive fins supported in upstanding relation from the outer surfaces of the container and thermally connected to the peripheral walls of the container.

11. The thermal battery of claim 1 wherein the heat transfer assembly is configured to circulate the heat transfer medium about the thermal core from a top to a bottom thereof.

12. The thermal battery of claim 1, in combination with a heat pump operatively connected to the heat exchanger so as to cooperate therewith in a heat transfer loop to release the extracted thermal energy outside the thermal battery, wherein the heat pump is configured to be actuated to extract thermal energy from the heat transfer medium in the housing when a temperature of the heat transfer medium is below a prescribed threshold temperature.

13. The thermal battery of claim 1 further including a vacuum pump in fluidic communication with the interior of the housing and an exterior environment of the housing, wherein, when the housing is fluidically sealed, the vacuum pump is configured to (i) release the fluidic heat transfer medium to the exterior environment of the housing, so as to form a vacuum pressure in the interior of the housing, when the heat exchanger is in an inactive state in which the heat transfer medium is not circulated, and (ii) admit the fluidic heat transfer medium to the interior of the housing from the exterior environment, when the heat exchanger is activated from the inactive state to circulate the heat transfer medium.

14. The thermal battery of claim 13 wherein, when the vacuum pump is external to the housing, a connection port of the vacuum pump is communicated with the ducting of the housing at a location downstream from the heat exchanger relative to flow of the heat transfer medium, such that the heat transfer medium passes through the heat exchanger upon evacuation from the housing by the vacuum pump.

15. The thermal battery of claim 1 wherein the phase change material is bitumen.

16. The thermal battery of claim 15 wherein the bitumen is residue collected from vacuum distillation of crude oil.

17. The thermal battery of claim 1 further including dampers in the ducting located adjacent the heat transfer assembly relative to flow of the heat transfer medium and configured to selectively isolate the heat exchanger from the thermal core.

18. The thermal battery of claim 17 wherein the dampers are configured to be positioned in an open position relative to the ducting to fluidically intercommunicate the heat exchanger and a portion of the ducting adjacent the thermal core when the heat transfer assembly is in an active state in which the heat transfer medium is circulating and wherein the dampers are configured to be positioned in a closed position relative to the ducting to obstruct the flow of the heat transfer medium when the heat transfer assembly is in an inactive state in which the heat transfer medium is not circulated.

19. The thermal battery of claim 1 wherein the fluidic pump of the heat transfer assembly comprises a centrifugal-type fan.

20. The thermal battery of claim 1 wherein the fluidic pump of the heat transfer assembly comprises a fan having a plurality of different speeds.

21. The thermal battery of claim 1 wherein the container of the thermal core and the walls of the compartments comprise aluminum.

22. The thermal battery of claim 1 wherein the housing comprises a frame, inner and outer enclosures supported by the frame in spaced relation to each other and thermal insulation between the inner and outer enclosures.

23. The thermal battery of claim 22 wherein walls of the inner and outer enclosures are corrugated.

24. A method of using a thermal battery to store and release thermal energy, the method comprising:
providing a phase change material in an enclosed thermally-conductive container to form a thermal core of the thermal battery;
electrically heating the phase change material of the thermal core to a prescribed temperature;
circulating, within a thermally insulated enclosure of the thermal battery receiving the thermal core, a fluidic heat transfer medium around the thermal core to extract thermal energy therefrom; and
conveying the extracted thermal energy outside the thermally insulated enclosure using a heat exchanger of the thermal battery operatively receiving the fluidic heat transfer medium.

25. The method of claim 24 wherein the phase change material is stored in the container under vacuum conditions.

26. The method of claim 24 wherein providing the phase change material comprises transferring, for storage in the enclosed thermally-conductive container, the phase change material at the prescribed temperature.

27. The method of claim 24 wherein the phase change material is bitumen.

28. The method of claim 24 wherein, when the phase change material is received in compartments formed within the container of the thermal core and when walls of the compartments are thermally-conductive, electrically heating the phase change material comprises applying electrically-generated heat to the walls of the compartments so as to heat the phase change material received in the compartments.

29. The method of claim 24 further including:
if a heat transfer assembly operatively connected to the heat exchanger is not operated to transfer the extracted thermal energy outside the enclosure, obstructing flow of the heat transfer medium to thermally isolate the heat exchanger from the thermal core.

30. The method of claim 24 wherein circulating, within a thermally insulated enclosure receiving the thermal core, a fluidic heat transfer medium comprises blowing air in a circulatory path along which lies the thermal core.

31. The method of claim 30 wherein the circulatory path is directed from a top to a bottom of the thermal core to be opposite to convectional airflow.

32. The method of claim 30 wherein a periphery of the thermal core between the top and the bottom also lies along the circulatory path.

33. The method of claim 24 further including exchanging the fluidic heat transfer medium between an interior of the enclosure and an exterior thereof in response to operation of a heat transfer assembly operatively connected to the heat exchanger to convey the extracted thermal energy outside the enclosure.

34. The method of claim 33 wherein exchanging the fluidic heat transfer medium between an interior and exterior of the enclosure in response to operation of the heat transfer assembly comprises:
transferring the fluidic heat transfer medium outside the enclosure to form a vacuum therein for reducing loss of thermal energy when the heat exchanger is in an inactive state; and
transferring the fluidic heat transfer medium into the enclosure for circulation around the thermal core when the heat exchanger is activated to transfer the extracted thermal energy outside the enclosure after being in the inactive state.

35. The method of claim 34 wherein, when the fluidic heat transfer medium is air, the fluidic heat transfer medium is exchanged between an interior of the enclosure and an ambient environment thereof.

36. The method of claim 33 wherein the fluidic heat transfer medium is guided past the heat exchanger during evacuation from the interior of the enclosure to the exterior thereof.
